(19) United States
(12) Patent Application Publication
(10) Pub. No.: US 2008/0032034 A1
(43) Pub. Date: Feb. 7, 2008

(54) Receiving Element For Receiving An Object Which Dissolved From A Biological Material By Means Of Laser Radiation

(75) Inventors: Yilmaz Niyaz, Augsburg (DE); Karin Schutze, Tutzing (DE)

Correspondence Address: EDWARDS ANGELL PALMER & DODGE LLP, P.O. BOX 55874, BOSTON, MA, 02205, US

(73) Assignee: P.A.L.M. Microlaser Technologies AG, Bernried (DE)

(21) Appl. No.: 10/582,832

(22) PCT Filed: Dec. 15, 2004
(86) PCT No.: PCT/EP04/14311

§ 371 Date: Mar. 26, 2007

(30) Foreign Application Priority Data
Dec. 15, 2003 (DE) 103 58 565.6

(51) Int. Cl. G01N 1/28

(52) U.S. Cl. 427/2.11; 118/713

(57) ABSTRACT

Receiving element for receiving a specimen detached from a biological mass by means of laser radiation A receiving element (1) is provided for receiving a specimen detached from a biological mass (7) by means of laser radiation, the receiving element (1) comprising a receiving surface for receiving the specimen, the receiving surface comprising an adhesive agent (4) for enhancing the adhesion of the respective specimen to the receiving surface. The adhesive agent (4) suppresses the occurrence of electrostatic forces, acting on the specimen, in the receiving element (1), may be dissolved without damaging the specimen and/or may receive agents for further processing of the specimen. A suitable adhesive agent (4) is in particular a hydrogel such as for example agarose. Such a receiving element (1) is suitable in particular for collecting specimens catapulted out of the biological mass (7).

The present invention relates to a receiving element for receiving a biological specimen which has been detached, and in particular catapulted out, i.e. detached by transmission of a momentum, from a biological mass by means of laser radiation.

WO 97/29355 A from the present applicant proposes a novel method for sorting and recovering individual biological specimens which are arranged on a carrier. In particular, it is proposed in said publication to separate a previously selected biological specimen from the surrounding further biological mass by a laser beam, such that the selected biological specimen is dissected out of the further biological mass. The dissected out biological specimen is then catapulted with the assistance of a laser pulse from the carrier to a collecting device where it is collected and held by a collecting or receiving element, in particular in the form of a pot-shaped container. With appropriate adjustment of laser power and/or laser focal point, it is also possible to catapult the selected biological specimen directly out of the surrounding biological mass with the assistance of just one single laser pulse, such that separate laser irradiation for cutting out the desired biological specimen is not necessary.

For the purposes of the present patent application, “biological specimens” are generally taken to mean any biological cells, in particular in a live or immobilised state, or cellular constituents which are a constituent of a liquid or solid biological material, such as for example of a cellular tissue, microtome preparations thereof, of a swab sample or of a cell culture etc.

The present invention is described below with reference to the field of application of processing biological specimens.

FIG. 3 shows the structure of a laser-microscope system as may be used with an above-described collecting device or an above-described receiving or collecting element. The system is of modular structure and may thus be individually adapted to different experimental requirements.

The system shown in FIG. 3 comprises a laser device 17, in which a laser light source for generating a laser light beam is accommodated. Furthermore, a lens system 15, 16 is accommodated in the laser device 17, which system is necessary for coupling the laser beam into a microscope 13 and adjusting the laser focal point in the specimen plane to the optical focal point of the microscope 13. In the present case, the laser may comprise a pulsed UV nitrogen laser. A control panel may be provided in order to control the laser device 17, with the assistance of which panel laser power and/or laser focal point may be set to desired values. A quartz filter 15 is arranged perpendicularly to the laser beam path for precise adjustment of laser power, the position of which filter may be controlled as a function of the adjustments made on the control panel in order to adjust laser power accordingly. The quartz filter 5 may here be adjusted both automatically and manually. In addition to adjustment of laser power, the laser focal point may also be adjusted independently of the microscope focal point, i.e. the focal point of the laser may be displaced in the Z direction relative to the specimen plane of the microscope 13. The laser focal point may also be adjusted both automatically and manually as a function of the adjustments made on the control panel by a corresponding movement of the lenses 16. The pulse rate of the laser may preferably also be adjusted by means of the stated control panel, the adjustment made on the control panel being displayed.

The laser beam is coupled into the microscope 13 via a plurality of coated beam splitters and deflected to an objective 12. The laser beam emitted via the objective 12 finally impinges on a motorised and computer-controlled microscope or specimen stage 14, on which is arranged a microscope slide with a biological mass to be processed. Above the specimen stage 14 there is located a likewise motorised and preferably computer-controlled collecting device 19, which comprises one or more receiving or collecting elements or collecting vessels 1. Components 14 and 19 permit exact specimen positioning and precise collection of biological or nonbiological specimens which are catapulted out and upwards from the mass located on the specimen stage 14 by means of laser irradiation.

The microscope 13 may be of any desired design. In particular, it is in principle conceivable to use not only an inverted microscope (as shown in FIG. 3) but also an upright microscope or a laser microscope. The microscope 13 is equipped with a video camera which photographs the area of the microscope slide or specimen stage 14 above the objective 12. The video signal of this video camera is supplied to a conventional commercial computer 18 and subjected therein to image processing in such a manner that the corresponding video image may be displayed in real time on the screen or monitor 8 of the computer 18.

In the computer 18 or the software running thereon, various functions are implemented which permit computer-assisted, i.e. automatic, actuation both of the laser device 17 and also of the microscope 13 or of the specimen stage 14 and the collecting device 19, such that for example the laser is automatically activated and the collecting device 19 and the specimen stage 14 may be automatically displaced and adjusted. Conventional input means, such as for example a keyboard 9, a computer mouse 10 or (not shown) a trackball, joystick or the like are provided to adjust or select these functions. Furthermore, a foot switch 11 is assigned to the laser device 17, actuation of which switch allows manual activation of the laser.

In order to cut the biological mass located on the microscope slide or the specimen stage 14, the user may, with computer assistance, specify a suitable cutting line which is implemented by corresponding actuation of the laser device 17 and of the specimen stage 14 in a corresponding relative motion between the laser beam and the specimen stage 14, such that simultaneous activation of the laser device 17 effects cutting of the biological mass in accordance with the predetermined section line by means of the laser beam.

A specimen cut out in this manner from the biological mass can be catapulted with the assistance of further laser irradiation out of the biological mass to the collecting device 19 located thereover. To this end, the specimens to be catapulted may be defined or marked with computer assistance and then the specimen stage 14 may be adjusted automatically in such a manner that the specimens to be catapulted are moved in succession over the laser beam and, by initiation of a short laser pulse, also known as a laser shot, in each case catapulted out of the specimen plane to the collecting device 19. Apart from the above-described automatic production of a laser pulse an individual laser impulse or laser pulse may also be initiated by brief pressure on the foot switch 11 shown in FIG. 3.

As has already been mentioned above, it is in principle also possible to catapult individual specimens directly out of the surrounding biological mass by appropriate laser irradiation if laser power and/or laser focal point are appropriately adjusted such that prior cutting out is then no longer required.

The collecting device 19, which in the inverted system shown in FIG. 3 is located above the specimen stage 14 or the specimen plane, comprises one or more receiving or collecting elements which collect and then retain the specimen catapulted out from the specimen plane. By focussing the microscope 13 on the collecting device 19 or the receiving or collecting element 1 which is in each case located in the light path of the microscope 13, the biological or nonbiological specimen which has been catapulted out and held by the corresponding receiving or collecting element may then be observed and investigated via the microscope 13 or the screen 8 of the computer 18, wherein for this purpose adjusting means are preferably provided for adjusting the collecting device 19 parallel to the specimen plane in order, using the microscope 13, to be able to scan the specimen which has been catapulted out and held in the corresponding receiving or collecting element 1.

It should be noted that the distance between the collecting device 19 and the carrier 14 is not to scale in the drawings. It is desirable here to provide the smallest possible distance in order to permit precise collection of the catapulted out specimens.

In order to ensure secure adhesion of the catapulted out specimen to a receiving surface of the receiving element 1, it is known to provide such a receiving surface with an adhesive layer. However, the problem then often arises of detaching the specimens from this adhesive layer for further processing without causing damage. In addition, for example when a person touches the receiving element, electrostatic forces may arise which attract the specimen as a result of which the specimen does not correctly reach the receiving surface. Such electrostatic charging may also be produced by the action of the laser beam. In order to avoid this, a liquid is conventionally placed in the receiving unit which is intended to prevent electrostatic forces from arising. This has the disadvantage that this liquid must be introduced beforehand, which takes time and entails a risk of contamination. In addition, such a liquid may evaporate and must accordingly be introduced into the receiving unit relatively shortly before catapulting, which may be problematic in multiple receiving units, such as for example microtitre plates.

Furthermore, there is the risk with conventional adhesive agents that difficulties may arise in detaching the specimen from the adhesive agent without destroying it.

For further processing of the specimens, for example for recovering a cell culture or a biological mass, it may be necessary to add for example nutrient solutions or other agents for further processing. This again gives rise to an elevated risk of contamination.

It is accordingly an object of the present invention to provide a receiving unit which avoids at least some of the stated problems. In particular, it is desirable to be able to produce such a receiving unit in advance, for example for mass processing of biological material and to be able to carry out further processing of catapulted out or detached specimens in as sterile a manner as possible.

Said object is achieved by a receiving element according to claim 1, 6, 7 or 8. The dependent claims define preferred exemplary embodiments of the receiving element, a preferred use of the receiving element and a method for recovering a biological specimen using the receiving element.

The present invention provides a receiving element for receiving a specimen detached from a biological mass by means of laser radiation, the receiving element comprising a receiving surface for receiving the specimen and the receiving surface comprising an adhesive agent for enhancing the adhesion of the respective specimen to the receiving surface. This adhesive agent is designed according to the invention such that it suppresses the occurrence electrostatic forces, acting on the specimen, in the receiving element. According to a further aspect of the invention, the adhesive agent may be dissolved without damaging the specimen, for example may be liquefied by input of heat. “Without damage” means in this context that predetermined processing and/or analysis of the specimen is not impaired. In addition or alternatively, the adhesive agent may be designed in such a manner that it can accommodate agents for further processing and/or analysis of the specimen, such as for example a buffer solution, a nutrient solution and/or enzymes or enzyme prebatches for example for a polymerase chain reaction (PCR). It is of course particularly preferred to provide an adhesive agent which comprises two or all three of these features.

The invention furthermore provides a receiving element of this generic type in which the adhesive agent is a hydrogel. This hydrogel may in particular exhibit the above-stated properties. A hydrogel is generally taken to mean a gel based on hydrophilic, but water-insoluble polymers, which in particular assume the form of a three-dimensional network. The polymers may here be both natural polymers and synthetic polymers. One possible such hydrogel is agarose.

In a preferred exemplary embodiment, the receiving element comprises a lid portion for covering a container and a base portion fitted in the lid portion with the receiving surface on a side remote from the lid portion. The base portion is here preferably of a height which is so selected that the distance from the receiving surface to a base of the container in a state in which the lid portion is covering the container is less than 10 mm and preferably between 1 and 3 mm. If a laser radiation-transmitting container, in particular a Petri dish with double membrane base, is used as the container, said container may then be directly used as a carrier for the biological mass and the specimen may simply be catapulted onto the receiving surface when the lid portion is covering the container.

The receiving element may also take the form of a multiple culture dish, Petri dish or a microtitre plate in each case having a plurality of receiving wells, the receiving wells being filled up to a specific height with the hydrogel.

The present invention is explained in greater detail below with reference to the attached drawings and to preferred exemplary embodiments. In the drawings:

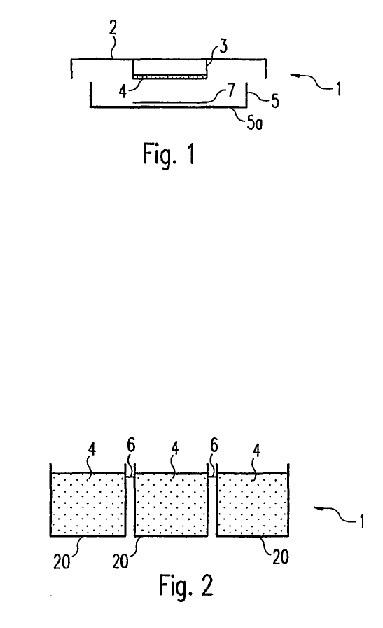

FIG. 1 shows a first exemplary embodiment of the present invention,

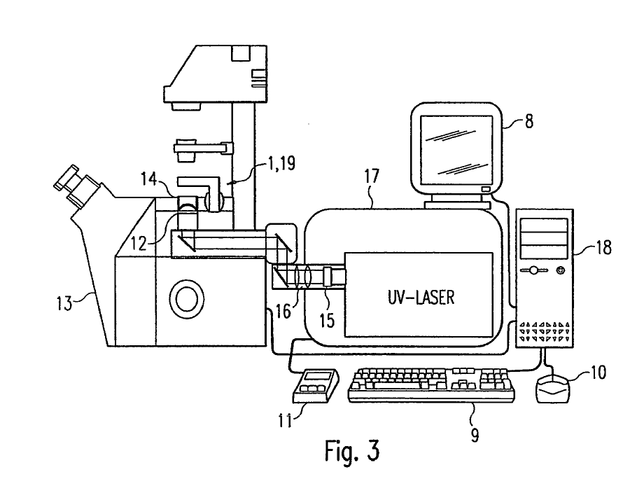

FIG. 2 shows a second exemplary embodiment of the present invention, and

FIG. 3 shows a laser system in which the present invention may be used.

FIG. 1 shows a first exemplary embodiment of the invention. A receiving element 1 according to the invention here comprises a cover or a lid 2 of a cell culture dish 5, for example a Petri dish. A base or supporting element 3 is fitted on the inside of the lid 1. The supporting element 3 may here for example be circular and be made from silicone or acrylic polymer, other materials also being conceivable. For many applications, it is desirable for this supporting element 3 to be autoclavable so that the receiving element may be sterilised. For this purpose, the supporting element 3 is sterilised and the agarose layer 4 applied by casting high-percentage, sterilised, filtered agarose into an appropriate template. The supporting element 3 is attached by a non-toxic material to the inner surface of the lid 2, wherein this connection is reversible so as to be able to remove the supporting element 3 again if required.

On a lower side of the supporting element 3 there is a receiving surface for in particular biological specimens, which is covered with an agarose layer 4 preferably consisting of high-quality, i.e. high purity LE agarose. The agarose layer serves as an adhesive agent for securing the specimens to the receiving surface. In principle, another suitable hydrogel or another adhesive agent with the desired properties may also be used instead of the agarose layer 4.

For the catapulting process described in detail with reference to FIG. 3 in the introduction to the description, the lid 2 is placed on a suitable Petri dish 5. Instead of a conventional glass base, the Petri dish 5 preferably comprises a double membrane 5a as base element, which consists of a combination of a light-transmitting and a Lw-absorbing film. Such a Petri dish is described in detail in DE 100 39 979 A1. This Petri dish 5 contains a cell culture 7 for example on the double membrane 5a. When assembled, the distance between the receiving surface or the hydrogel 4 and the membrane 5a is less than 10 mm, preferably in the range from 1 to 3 mm. The vessel closed in this way is then inserted as carrier 14 into the apparatus of FIG. 3. Using a laser beam, a desired part of the cell culture 7 is cut out and catapulted by means of a laser pulse onto the hydrogel 4. The receiving element 1 thus at the same time replaces a collecting means 19 as illustrated in FIG. 3.

For further processing, the receiving element 1 is then placed for example on a cell culture vessel or indeed on a further Petri dish 5 with membrane 5a. The cells catapulted onto the hydrogel 4 may be detached by gentle motion or by heating the agarose layer 4. The further Petri dish 5 may in particular be filled with a cell culture liquid, into which the hydrogel 4 dips. Alternatively, the hydrogel layer may also be completely dissolved by the addition of agarase, an enzyme which dissolves agarose. Then the receiving element 1 may be replaced with a conventional lid and reused, optionally after sterilisation. If the catapulted cells are transferred in this way into a further Petri dish 5 with membrane 5a, the process may be repeated after culturing in this Petri dish with the cell cultures which arise therein.

Use of the hydrogel, in this case the agarose layer 4, has the advantage that electrostatic forces produced for example by the laser irradiation or by contact do not result in the cells which have been catapulted out remaining attached to the lid 2 instead of on the hydrogel layer 4.

Another advantage of using such a receiving means is that the agarose layer 4 allows better visualisation of the cell culture 7 and the catapulted-out cells with a microscope, since contrast is improved.

FIG. 2 shows a second exemplary embodiment of the present invention. Here, the receiving element 1 takes the form of so-called multiple culture dishes, i.e. a plurality of connected dish-like wells 20. In the example illustrated, three such dishes 20 are shown, these being connected by webs 6. The dishes may be covered with a lid (not shown). With conventional commercial multiple culture dishes or multiple culture plates, substantially more of these dishes 20 are conventionally present, for example four rows each with six such dishes 20. The dishes are again filled with agarose 4 or another hydrogel. In a catapulting process as described above, this arrangement is accordingly fitted with its opening pointing downwards into the receiving means 19 of the microscope illustrated in FIG. 3, and the desired cells are catapulted onto the agarose layer 4 from a carrier 14. The level to which the dishes are filled with agarose is so selected that the spacing relative to the carrier 14 is favourable to catapulting, being preferably between 1 and 3 mm.

After catapulting, the agarose 4 may again be liquefied by the addition of agarase, such that immediate re-use is possible. Moreover, different additives such as for example cell culture media or buffer solutions may be introduced in the agarose layers 4. For subsequent processing or analysis of the catapulted cells, additional introduction of these agents is therefore no longer necessary, since they are liberated once the agarose has been dissolved or liquefied. Enzymes or enzyme prebatches may in this case also serve as additives. One operation is therefore dispensed with, so avoiding the associated risk of contamination, since these additives do not have to be added for example by pipetting, and the desired processing and/or analysis may be initiated immediately. One preferred field of application is in this case the polymerase chain reaction (PCR), wherein the additives may preferably be so selected that the reaction is initiated at the same time as dissolution of the hydrogel by heating. Another field of application is culturing of the catapulted cells.

In such applications, care must be taken to ensure that the dissolved hydrogel does not interfere with or contaminate the intended processing or analysis. High purity, preferably sterilised agarose is here too an example of a suitable hydrogel.

Instead of multiple culture dishes, so-called microtitre plates or 96-well microtitre plates may also be filled, as in FIG. 2, with fine-pore, finely gelling agarose, such that once again optimum spacing is provided for a catapulting process. Here too, mixtures desired for further processing of the catapulted cells may again be admixed with the agarose, for example reaction mixtures such as denaturing buffer solutions or enzyme-containing prebatches. Thus, a desired reaction may be initiated for all harvested cells at the same time. Since the agarose may be dissolved by the agarase enzyme, the full volume of the respective wells is available for subsequent applications such as PCR or MALDI (polymerase chain reaction or matrix-assisted laser desorption/ionisation). In such applications, instead of dissolution of the agarose by means of agarase, the agarose may also be liquefied by cyclic heating of the sample for example during the PCR process.

It goes without saying that the exemplary embodiments described here are not limited to agarose as hydrogel, it also being possible to use other hydrogels with the desired properties. For example, a hydrogel based on collagen, polyacrylamide or similar substances would be possible here. The receiving units may also assume different forms, depending on the desired application.

1-30. (canceled)

31. A receiving element for receiving a biological specimen detached from a biological mass by laser radiation, comprising:
a receiving element comprising a receiving surface for receiving the specimen,
the receiving surface comprising an adhesive agent for enhancing the adhesion of the respective specimen to the receiving surface,
wherein the adhesive agent is dissolvable without impairing the suitability of the specimen for predetermined processing and/or analysis.

32. The receiving element according to claim 31, wherein, for dissolution, the adhesive agent is liquefiable by input of heat.

33. The receiving element according to claim 31, wherein the adhesive agent is dissolvable without damaging the specimen.

34. The receiving element according to claim 31, wherein the adhesive agent comprises agents for carrying out the predetermined processing and/or analysis.

35. The receiving element according to claim 31, wherein the adhesive agent is so designed that, after dissolution, it does not influence the predetermined processing and/or analysis.

36. A receiving element for receiving a biological specimen detached from a biological mass by laser radiation, comprising:
a receiving element comprising a receiving surface for receiving the specimen,
the receiving surface comprising an adhesive agent for enhancing the adhesion of the respective specimen to the receiving surface,
wherein the adhesive agent can suppress the occurrence of electrostatic forces, acting on the specimen, in the receiving element.

37. A receiving element for receiving a biological specimen detached from a biological mass by laser radiation,
a receiving element comprising a receiving surface for receiving the specimen,
the receiving surface comprising an adhesive agent for enhancing the adhesion of the respective specimen to the receiving surface,
wherein the adhesive agent is so designed that it may receive agents for further processing and/or analysis of the specimen.

38. A receiving element for receiving a biological specimen detached from a biological mass by laser radiation,
a receiving element comprising a receiving surface for receiving the specimen,
the receiving surface comprising an adhesive agent for enhancing the adhesion of the respective specimen to the receiving surface,
wherein the adhesive agent is a hydrogel.

39. The receiving element according to claim 38, wherein the hydrogel is so designed that it suppresses the occurrence of electrostatic forces, acting on the specimen, in the receiving element.

40. The receiving element according to claim 38, wherein the hydrogel is dissolvable without damaging the specimen.

41. The receiving element according to claim 40, wherein the hydrogel is dissolvable by addition of an enzyme.

42. The receiving element according to claim 40, wherein, for dissolution, the hydrogel is liquefiable by input of heat.

43. The receiving element according to claim 38, wherein the hydrogel is so designed that it may receive agents for further processing and/or analysis of the specimen.

44. The receiving element according to claim 43, wherein the agents for further processing and/or analysis of the specimen are incorporated in the hydrogel.

45. The receiving element according to claim 44, wherein the agents for further processing of the specimen comprise buffer agents, a cell culture medium and/or an enzyme prebatch.

46. The receiving element according to claim 38, wherein the hydrogel comprises agarose.

47. The receiving element according to claim 46, wherein the hydrogel consists of pure agarose.

48. The receiving element according to claim 38, wherein the hydrogel comprises at least one of a hydrogel based on proteinogenic substances, collagen, a sugar-based network former and a polyacrylamide.

49. The receiving element according to claim 38, wherein the receiving element comprises a lid portion for covering a container and a supporting element fitted in the lid portion, said supporting element having the receiving surface on a side remote from the lid portion.

50. The receiving element according to claim 49, wherein the supporting element is made of silicone or acrylic polymer.

51. The receiving element according to claim 49, wherein the supporting element has a height which is so selected that the distance between the hydrogel and a base of the container is less than 10 mm when the lid portion is covering the container.

52. The receiving element according to claim 49, wherein the supporting element is fitted removably on the lid portion.

53. The receiving element according to claim 38, wherein the receiving element takes the form of a multiple culture dish.

54. The receiving element according to claim 38, wherein the receiving element takes the form of a microtitre plate.

55. The receiving element according to claim 38, wherein receiving wells of the receiving element are filled to a predetermined level with the adhesive agent.

56. A method of obtaining a biological specimen, comprising:
detaching the specimen with a laser from a biological mass, transporting the specimen with a laser pulse to a receiving element, receiving the specimen on a receiving surface of a receiving element, said preceiving surface comprising an adhesive agent, and dissolving the adhesive agent of the receiving element.

57. The method according to claim 56, further comprising liberating agents incorporated in the adhesive agent for at least one of further processing and analysis of the biological specimens when dissolving said adhesive agent.

58. The method according to claim 56, wherein said dissolving step is performed without impairing the suitability of the specimen for a further processing.

59. The method according to claim 56, wherein said adhesive agent comprises a hydrogel.

60. The method according to claim 59, wherein said hydrogel comprises at least one of agarose, a proteinogenic substance, a collagen, a sugar-based network former and polyacrylamide.

61. The method according to claim 56, wherein said detaching and transporting steps comprise performing a laser-triggered transportation process.
